(19) United States
(12) Patent Application Publication
(10) Pub. No.: US 2015/0269127 A1
(43) Pub. Date: Sep. 24, 2015

(54) RESOURCE ADAPTIVE APPARATUS, METHOD, AND NON-TRANSITORY COMPUTER READABLE STORAGE MEDIUM THEREOF

(71) Applicant: MEDIATEK INC., Hsinchu (TW)

(72) Inventors: Tzu-Wen CHANG, Taipei City (TW); Kai-Wen LIU, Taipei City (TW)

(21) Appl. No.: 14/607,519

(22) Filed: Jan. 28, 2015

Related U.S. Application Data
(60) Provisional application No. 61/955,872, filed on Mar. 20, 2014.

(51) Int. Cl. G06F 17/21

(52) U.S. Cl. CPC G06F 17/212

(57) ABSTRACT

Resource adaptive apparatuses, methods, and non-transitory computer readable storage media thereof are provided. The resource adjustable electronic apparatus includes a first display unit and a processing unit. The processing unit executes an application program, assigns a system display configuration that corresponds to a first resource as a local display configuration of the application program, detects a predetermined event, and updates the local display configuration of the application program in response to the predetermined event being detected. In this way, the application program loads a second resource according to the updated local display configuration and renders the second resource on at least one of the first display unit and a second display unit after the predetermined event is detected.

### CROSS-REFERENCE TO RELATED APPLICATION

This application claims the benefit of U.S. Provisional Application Ser. No. 61/955,872 filed on Mar. 20, 2014, which is hereby incorporated by reference in its entirety.

### BACKGROUND OF THE INVENTION

1. Field of the Invention

The present invention relates to resource adaptive apparatuses, methods, and non-transitory computer readable storage media thereof. More particularly, the present invention relates to resource adaptive apparatuses, methods, and non-transitory computer readable storage media thereof that adjust resource(s) in response to the detection of a predetermined event.

2. Descriptions of the Related Art

Application programs executed on an electronic apparatus require resources and some of the resources are related to human visual perception, such as display layouts of application programs, images to be rendered on a display unit, etc. A conventional resource loading mechanism is described below, which is adopted in many conventional electronic apparatuses (e.g. an electronic apparatus installed with an Android operating system).

According to the conventional resource loading mechanism, an electronic apparatus decides a system configuration initially and broadcasts the system configuration to the application programs executed on the electronic apparatus. Each of the application programs adopts the system configuration as its own local configuration, loads resource(s) according to the local configuration, and renders the visual-related resource(s) on a display unit. Briefly speaking, when using this conventional resource loading mechanism, an application program loads resource(s) according to the system configuration.

When an application program is executed on the electronic apparatus, there are occasions that the display environment for the application program changes. For example, when the application program is switched from working in a single-window environment to working in a multi-window environment on the electronic apparatus, the display environment for the application program changes. Yet as another example, when the electronic apparatus is electrically connected to an external electronic apparatus and makes a display unit of the external electronic apparatus renders the application program, the display environment for the application program changes. According to the conventional resource loading mechanism, an application program loads visual-related resource(s) according to the system configuration initially. It means that an application program loads visual-related resource(s) according to the original display environment of the application program. When the display environment for the application program has been changed, the initially loaded visual-related resource(s) become inadequate for the new display environment for the application program. Hence, unpleasant visual experience occurs.

According to the above descriptions, resource loading mechanisms that can adjust and load visual-related resources for application programs when the display environment for the application programs has been changed is still in an urgent need.

### SUMMARY OF THE INVENTION

To solve the aforementioned problems, the present invention provides a resource adaptive apparatus, a resource adaptive electronic method, and a non-transitory computer readable storage medium thereof.

The resource adaptive apparatus comprises a first display unit and a processing unit, wherein the processing unit is electrically connected to the first display unit. The processing unit is configured to execute an application program, assign a system display configuration that corresponds to a first resource as a local display configuration of the application program, detect a predetermined event, update the local display configuration of the application program in response to the predetermined event being detected. The application program loads a second resource according to the updated local display configuration and renders the second resource on at least one of the first display unit and a second display unit after the predetermined event is detected.

The resource adaptive method is for use in an electronic device, which comprises the following steps of: (a) executing an application program, (b) assigning a system display configuration that corresponds to a first resource as a local display configuration of the application program, (c) detecting a predetermined event, and (d) updating the local display configuration of the application program in response to the predetermined event being detected so that the application program loads a second resource according to the updated local display configuration and renders the second resource on a display unit after the predetermined event is detected.

The non-transitory computer readable storage medium has a computer program stored therein. The computer program executes a resource adaptive method after being loaded into an electronic device. The resource adaptive method comprises the following steps of: (a) executing an application program, (b) assigning a system display configuration that corresponds to a first resource as a local display configuration of the application program, (c) detecting a predetermined event, and (d) updating the local display configuration of the application program in response to the predetermined event being detected so that the application program loads a second resource according to the updated local display configuration and renders the second resource on a display unit after the predetermined event is detected.

According to the present invention, an electronic apparatus (or the like) initially assigns a system display configuration as a local display configuration of an application program executed on the electronic apparatus. When a predetermined event is detected (e.g. when the display environment for the application program changes), the electronic apparatus updates the local display configuration of the application program in response to the predetermined event being detected. In this way, after the predetermined event is detected, the application program loads resource(s) according to the updated local display configuration. Since the resource(s) are loaded based on the updated local display configuration, rendering these resource(s) on the display unit provides pleasant visual experience.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a resource adaptive apparatus 1 of the first and second embodiments of the present invention;

FIG. 2A illustrates a single-window environment for displaying an application program;

FIG. 2B illustrates a multi-window environment for displaying an application program;

FIG. 3A is a schematic view of a resource adaptive apparatus 3 of the third embodiments of the present invention;

FIG. 3B illustrates a display range for rendering an application program in the portrait mode when the display unit 301 is placed in the portrait mode;

FIG. 3C illustrates a display range for rendering an application program in the portrait mode when the display unit 301 is placed in the landscape mode;

FIG. 3D illustrates the concept of loading a resource according to original local display configuration;

FIG. 3E illustrates the concept of loading a resource according to updated local display configuration;

FIG. 4 illustrates the flowchart of the resource adaptive method in the fourth embodiment;

FIG. 5 illustrates the flowchart of the resource adaptive method in the fifth embodiment; and

FIG. 6 illustrates the flowchart of the resource adaptive method in the sixth embodiment.

### DESCRIPTION OF THE PREFERRED EMBODIMENT

In the following descriptions, the resource adaptive apparatuses, methods, and non-transitory computer readable storage media thereof will be explained with reference to embodiments thereof. Nevertheless, these embodiments are not intended to limit the present invention to any environments, applications, or implementations described in these embodiments. Therefore, the description of these embodiments is only for the purpose of illustration rather than to limit the scope of the present invention. It shall be appreciated that elements not directly related to the present invention are omitted from depictions in the following embodiments and attached drawings.

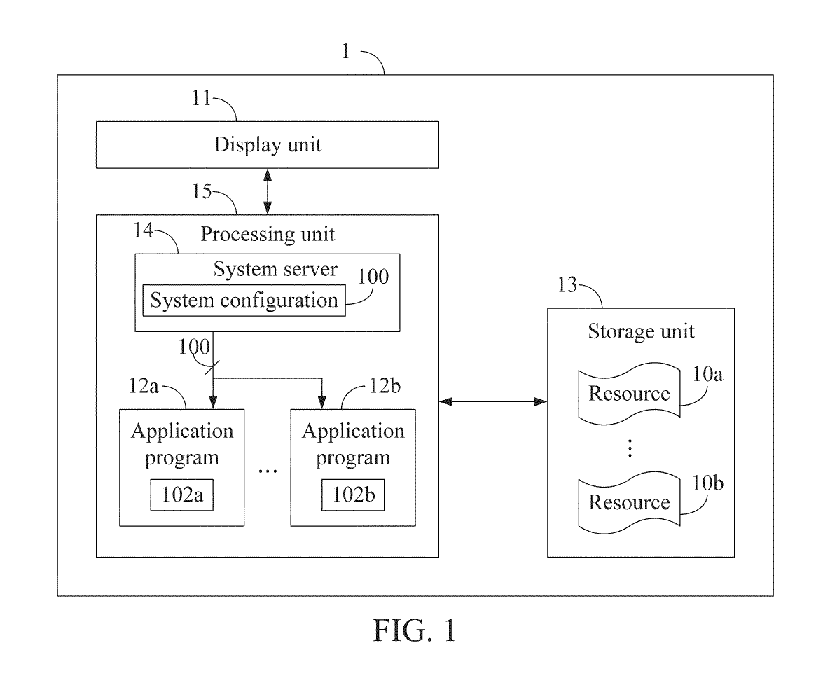

A first embodiment of the present invention is a resource adaptive apparatus 1 and a schematic view of which is illustrated in FIG. 1. The resource adaptive apparatus 1 comprises a display unit 11, a storage unit 13, and a processing unit 15, wherein the processing unit 15 is electrically connected to the storage unit 13 and the display unit 11.

The resource adaptive apparatus 1 may be any electronic apparatus that has processing/calculating abilities, such as a mobile phone, a tablet computer, or the like. The display unit 11 may be a liquid-crystal display (LCD), a light-emitting diode (LED) display, a (Organic Light Emitting Diodes) display, or the like. The storage unit 13 may be a memory, a Universal Serial Bus (USB) disk, a mobile disk, or any other storage media or circuit with the same function and well known to those of ordinary skill in the art. The processing unit 15 may be any of various processors, central processing units (CPUs), microprocessors, or other computing devices well known to those of ordinary skill in the art.

In this embodiment, the processing unit 15 executes a system server 14 and several application programs 12a, . . . , 12b. It is noted that the present invention does not limit the number of the application programs executed by the processing unit 15. The storage unit 13 is stored with several resources 10a, . . . , 10b, wherein each of the resources 10a, . . . , 10b may belong to one of the application programs 12a, . . . , 12b. Each of the resources 10a, . . . , 10b are visual-related resources, which means that each of them are related to human visual perception. It is emphasized that, in some other embodiments, the resources 10a, . . . , 10b may be stored in another storage unit external to the resource adaptive apparatus 1. In other words, the present invention does not limit the place/location for storing the resources of the application programs.

Initially, the processing unit 15 decides a system display configuration 100, which may be achieved by the system server 14 and based on an initial environment of the resource adaptive apparatus 1. Next, the processing unit 15 assigns the system display configuration 100 to the application programs 12a, . . . , 12b as their local display configuration 102a, . . . , 102b, which may be achieved by the system server 14 as well. Afterwards, the application programs 12a, . . . , 12b may respectively load resource(s) according to the local display configurations 102a, . . . , 102b and render the loaded resource(s) on the display unit 11. For example, the application program 12a may load the resource 10a according to its local display configuration 102a and render the resource 10a on the display unit 11. It means that the local display configuration 102a of the application program 12a (i.e. the system display configuration 100) corresponds to the resource 10a.

At some time instant, the processing unit 15 detects a predetermined event (not shown). For example, the predetermined event may be an event that the display environment for any of the application programs 12a, . . . , 12b changes. For convenience, it is assumed that the predetermined event is caused by the application program 12a; that is, the display environment for the application program 12a changes. In response to the predetermined event being detected, the processing unit 15 updates the local display configuration 102a of the application program 12a in response to the detection of the predetermined event. Afterwards, the application program 12a loads the resource (e.g. the resource 10b) according to the updated local display configuration 102a and renders the resource 10b on the display unit 11 and/or another display unit (not shown) after the predetermined event is detected.

According to the above descriptions, the processing unit 15 updates the local display configuration for an application program when a predetermined event happens to that application program. The concerned application program will load resource(s) according to the updated local display configuration and render the loaded resource(s) on a display unit. Since the resource(s) are loaded according to the updated local display configuration, rendering these resource(s) on the display unit provides pleasant visual experience.

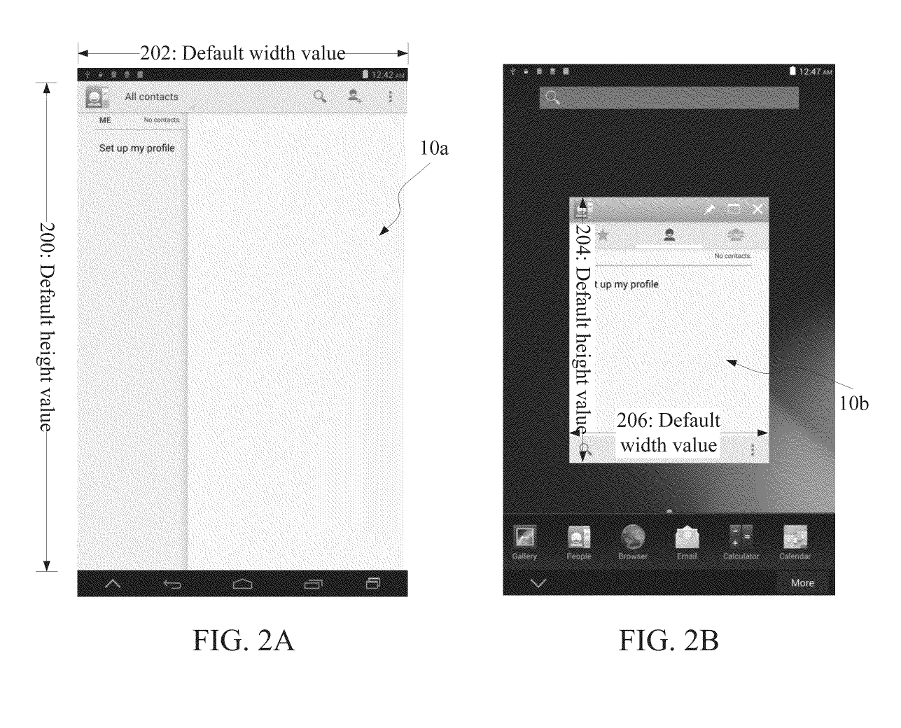

Please refer to FIG. 1, FIG. 2A, and FIG. 2B for a second embodiment of the present invention. In the second embodiment, the resource adaptive apparatus 1 is able to execute the operations, have the functionalities, and achieve the same technical results as those described in the first embodiment. In the following descriptions, only the differences between the first embodiment and the second embodiment are addressed.

In this embodiment, the resource adaptive apparatus 1 provides two types of working environments for the application programs 12a, . . . , 12b, including a single-window environment and a multi-window environment. The single-window environment is defined with a default height value 200 and a default width value 202 for displaying any of the application programs 12a, . . . , 12b as shown in FIG. 2A, while the multi-window environment is defined with a default height value 204 and a default width value 206 for displaying any of the application programs 12a, . . . , 12b as shown in FIG. 2B. In this embodiment, switching from working in the single-window environment to working in the multi-window environment is considered as a predetermined event because the switch makes the display environment for any of the application programs 12a, . . . , 12b change, and vise versa.

In this embodiment, each of the display configurations (including the system display configuration 100 and the local display configurations 102a, . . . , 102b) comprises a layout height value and a layout width value. In addition, each of the resources 10a, . . . , 10b is a display layout. The resource 10a is a first display layout having a dimension that is almost (or exactly) the same as the display area of the display unit 11 as shown in FIG. 2A, such as a layout for a tablet user interface. The resource 10b is a second display layout as shown in FIG. 2B, such as a phone layout. The first display layout and the second display layout are of different dimensions, wherein the dimension of the former is larger than that of the latter. It is noted that the term “the first” used in “the first display layout” and the term “the second” used in “the second display layout” are simply used for distinguishing two different display layouts.

Initially, the resource adaptive apparatus 1 provides the single-window environment. The processing unit 15 decides the system display configuration 100 based on this initial environment; hence, the layout height value and the layout width value of the system display configuration 100 are respectively decided to be equivalent to the default height value 200 and the default width value 202 of the single-window environment. Then, the processing unit 15 assigns the system display configuration 100 to the application programs 12a, . . . , 12b as their local display configuration 102a, . . . , 102b. As a result, the layout height value and the layout width value of each of the local display configuration 102a, . . . , 102b are respectively equivalent to the default height value 200 and the default width value 202.

It is assumed that the application program 12a is currently operated by a user. The application program 12a loads the resource 10a according to the layout height value and the layout width value of the local display configuration 102a. The resource 10a is loaded by the application program 12a because the dimension of the resource 10a is closest to the dimension defined by the layout height value and the layout width value of the local display configuration 102a comparing to other resources. Afterwards, the application program 12a renders the resource 10a on the display unit 11.

There are occasions that the application program 12a is switched from working in the single-window environment to working in the multi-window environment on the resource electronic apparatus 1. For example, the user triggers an icon representing the multi-window environment shown on the display area of the display unit 11. The processing unit 15 is able to detect the occasions that the multi-window environment is launched. In this embodiment, the multi-window environment being launched is one of the predetermined events.

In response to the detection that the multi-window environment is launched, the processing unit 15 updates the local display configuration 102a of the application program 12a by updating its layout height value and its layout width value. Since the working environment is switched to the multi-window environment, the processing unit 15 updates the layout height value and the layout width value of the local display configuration 102a by setting them to the default height value 204 and the default width value 206 of the multi-window environment. Afterward, the application program 12a loads the resource 10b according to the layout height value and the layout width value of the updated local display configuration 102a. The resource 10b is loaded by the application program 12a because the dimension of the resource 10b is closest to the dimension defined by the layout height value and the layout width value of the updated local display configuration 102a comparing to other resources. Next, the application program 12a renders the resource 10b on the display unit 11 as shown in FIG. 2B.

Considering the situation that the local display configuration 102a is not updated after the working environment is switched to the multi-window environment, the resource 10a will be rendered on the display area defined by the default height value 204 and the default width value 206. In this situation, an unpleasant visual experience occurs because the resource 10a (e.g. a layout for a tablet user interface) was designed for a larger display area. According to the above descriptions, the present invention can avoid the occurrence of this kind of unpleasant visual experiences because the local display configuration will be updated when the working environment changes.

Although the above descriptions are related to the situation that the working environment is switched from the single-window environment to the multi-window environment, the present invention can be applied to the situation that the working environment is switched from the multi-window environment to the single-window environment. People ordinary skilled in the art should be able to conceive the details for that kind of situation; hence, the details are not repeated.

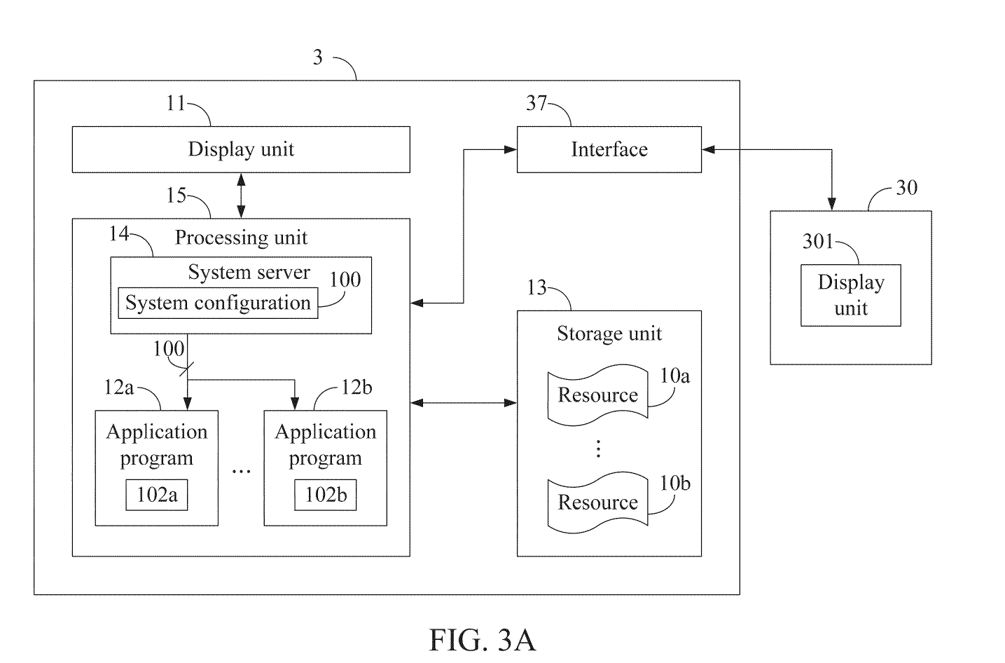

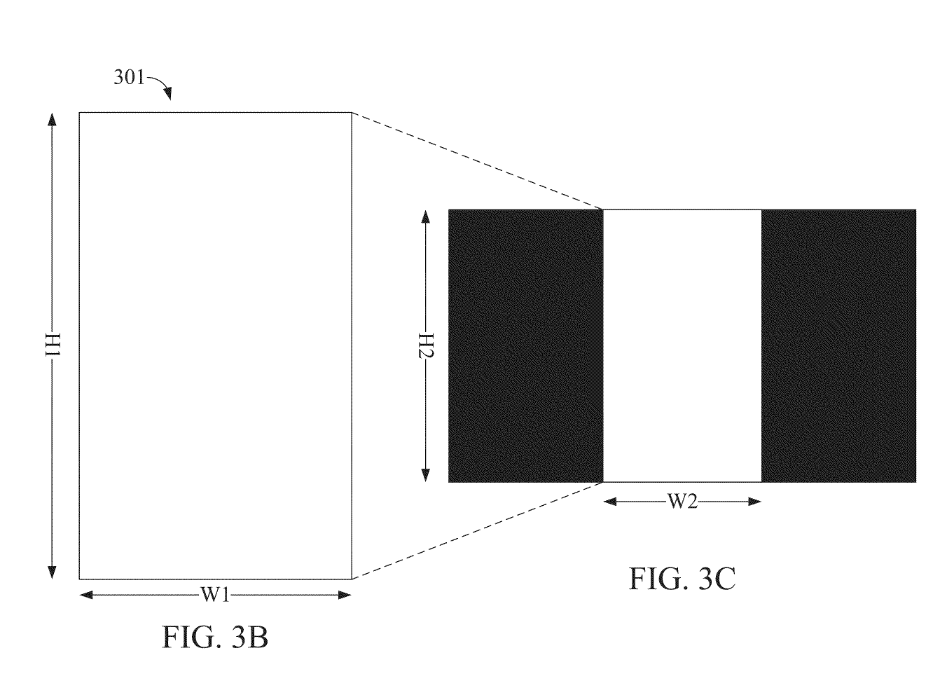

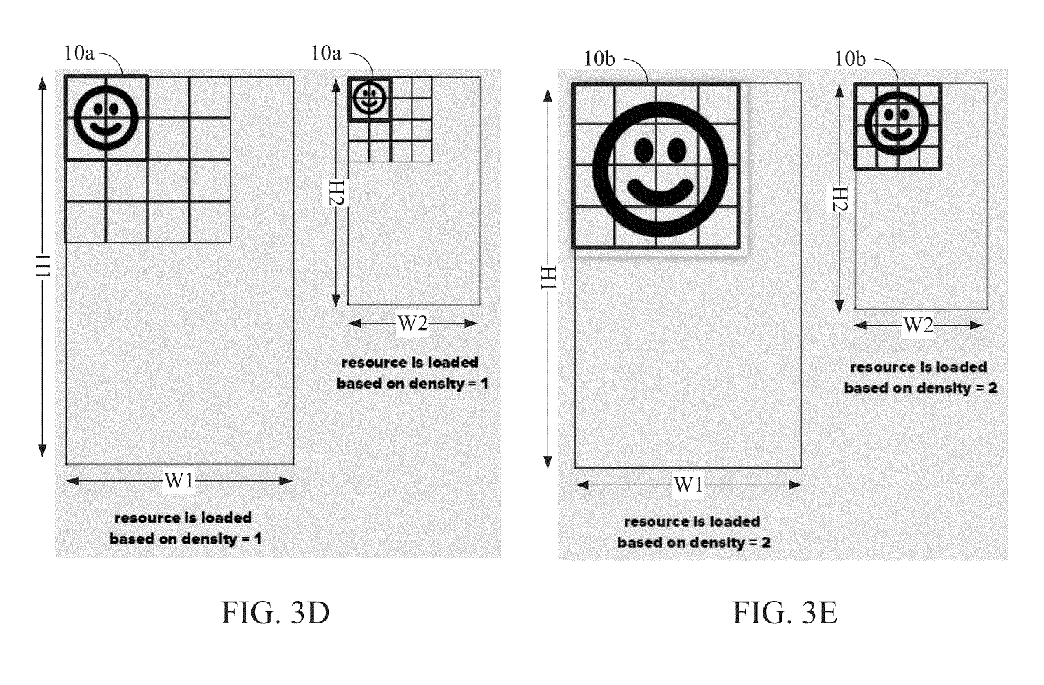

A third embodiment of the present invention is a resource adaptive apparatus 3 and a schematic view of which is illustrated in FIG. 3A. The resource adaptive apparatus 3 comprises a display unit 11, a storage unit 13, a processing unit 15, and an interface 37, wherein the processing unit 15 is electrically connected to the storage unit 13, the display unit 11, and the interface 37. The interface 37 may be any interface that can be connected to an external electronic apparatus having a display unit, such as a High-Definition Multimedia Interface (HDMI) or the like. It is noted that the present invention does not limit the types of the interface 37. In the third embodiment, the display unit 11, the storage unit 13, and the processing unit 15 are able to execute the operations, have the functionalities, and achieve the same technical results as those described in the first embodiment. In the following descriptions, only the differences between the first embodiment and the third embodiment are addressed.

Two different display modes including the first display mode and the second will be involved in this embodiment. It is noted that the term “the first” used in “the first display mode” and the term “the second” used in “the second display mode” are simply used for distinguishing two different display modes. For example, the first display mode may be a portrait mode, while the second display mode may be a landscape mode. Yet as another example, the first display mode may be a landscape mode, while the second display mode may be a portrait mode.

In this embodiment, when the interface 37 is connected to an external electronic apparatus having a display unit placed in a second display mode, a predetermined event is triggered if the application program currently operated by the user is designed to be rendered in the first display mode. That is, when the interface 37 is connected to an external electronic apparatus, a predetermined event is triggered if the two display modes (i.e. the display mode that the display unit of the external electronic apparatus is placed and the display mode that the application program is designed) are different.

Moreover, in this embodiment, each of the display configurations (including the system display configuration 100 and the local display configurations 102a, . . . , 102b) is a logical density of the display unit of the external electronic apparatus. The logical density indicates the number of pixels with in a certain length, such as the number of pixels per inch.

Initially, the application program 12a is operated by the user and the application program 12a is designed to be rendered in the first display mode. At some instant, the interface 37 is connected to an external electronic apparatus 30 having a display unit 301 placed in a second display mode. The processing unit 15 has the knowledge that the application program 12a is designed to be rendered in the first display mode. Hence, when the interface 37 is connected to the external electronic apparatus 30, the processing unit 15 detects the predetermined event because the first display mode and the second display mode are different. For convenience, it is assumed that the first display mode and the second display mode are respectively the portrait mode and the landscape mode in the following descriptions of the third embodiment.

Please refer to FIG. 3B and FIG. 3C. FIG. 3B illustrates a display range for rendering an application program in the portrait mode when the display unit 301 is placed in the portrait mode. The display range shown in FIG. 3B is defined by a first width W1 and a first height H1 for the portrait mode. FIG. 3C illustrates a display range for rendering an application program in the portrait mode when the display unit 301 is placed in the landscape mode. The display range shown in FIG. 3C is defined by a second width W2 and a second height H2. It is noted that the term “the first” used in “the first display range,” “the first height,” and “the first width” and the term “the second” used in “the second display range,” “the second height,” and “the second width” are simply used for distinguishing different display ranges, different heights, and different width.

Although the display unit 301 is placed in the landscape mode as shown in FIG. 3C, the processing unit 15 decides the system display configuration 100 according to the first display range (i.e. the display range when the display unit 301 is placed in the portrait mode, which is defined by the first width W1 and the first height H1) as shown in FIG. 3B after detecting the predetermined event. For convenience, it is assumed that the value of the system display configuration 100 is one. The processing unit 15 assigns the system display configuration 100 to the application programs 12a, . . . , 12b as their local display configuration 102a, . . . , 102b. At this stage, the application program 12a (i.e. the application program that is currently operated by the user) will not load a resource (e.g. the resource 10a) corresponding to the local display configuration 102a because rendering the resource 10a on the display unit 301 placed in the landscape mode will provide unpleasant visual experience.

Please be reminded again that the second display range (i.e. the display range when the display unit 301 is placed in the landscape mode, which is defined by the second width W2 and the second height H2) as shown in FIG. 3C is the target display range of the application program 12a. Hence, in response to the detection of the predetermined event, the processing unit 15 updates the local display configuration 102a of the application program 12a according to a relation between the first display range and the second display range. The relation between the first display range and the second display range may be described by a pillar box algorithm as follows,

$$Resize ratio = \frac{first height H 1}{second height H 2} = \frac{first width W 1}{second width W 2} .$$

In the meantime, please be noted that the aspect ratio of the first display range, the second display range, and the display unit 301 can be represented as follows,

$$Aspect ratio = \frac{first height H 1}{first height W 2} = \frac{second width H 1}{second width W 2}$$

As the value of the first width W1 is equal to the value of second height H2, it is understood that the resize ratio is equivalent to the aspect ratio. Hence, the processing unit 15 may update the local display configuration 102a of the application program 12a according to the aforementioned aspect ratio. For example, the processing unit 15 may derive the updated local display configuration 102a by multiplying the original local display configuration 102a by an integer closest to the aspect ratio. A concrete example is given herein. If the display unit 301 is of dimension 1366 by 768, the aspect ratio is around 2 (i.e.

$$⌈ \frac{1366}{768} ⌉ \approx 2 ) .$$

In this case, the updated local display configuration 102a becomes two (i.e. 1 multiplied by 2 makes 2). Afterwards, the application program 12a loads the resource 10b according to the updated local display configuration 102a and renders the resource 10b on the display unit 301.

Considering the situation that the local display configuration 102a is not updated, the resource 10a will be loaded as shown in the left portion in FIG. 3D. The resource 10a is derived based on the first display range; hence, resizing the resource 10a according to the above resize ratio and rendering the resized resource 10a result in unpleasant visual experience (e.g. too small) as shown in the right portion of FIG. 3D.

To avoid the unpleasant visual experience, the processing unit 15 updates the local display configuration 102a in response to the detection of the predetermined event. In this way, the resource 10b but not the resource 10a is loaded by the application program 12a as shown in the left portion in FIG. 3E. As a result, resizing the resource 10b according to the above resize ratio and rendering the resized resource 10b result in pleasant visual experience (e.g. the resource 10b appeared in appropriate size) as shown in the right portion of FIG. 3E. Please be reminded again that only the right portion of FIG. 3E will be actually displayed in this embodiment.

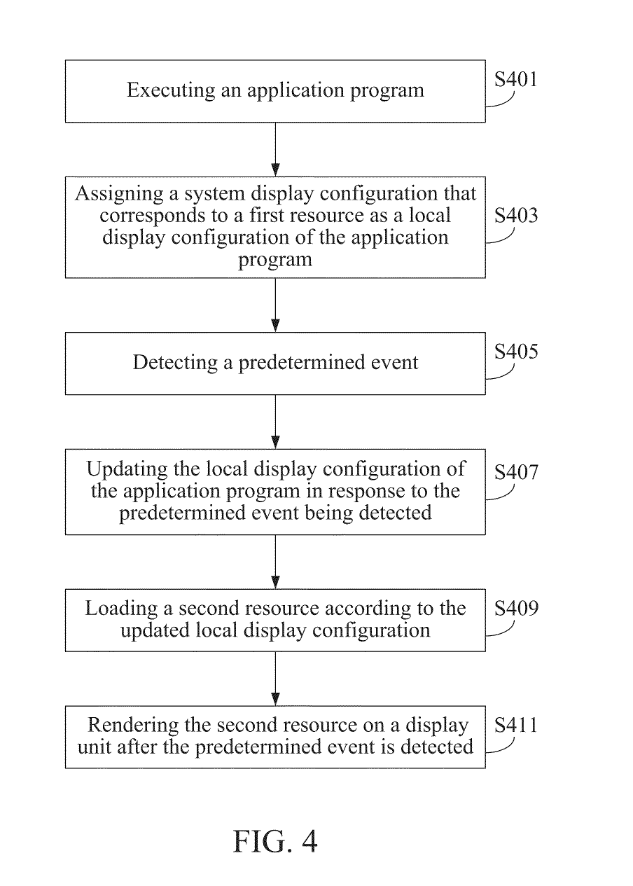

A fourth embodiment of the present invention is a resource adaptive method and a flowchart of which is illustrated in FIG. 4. The resource adaptive method is for use in an electronic device, such as the resource adaptive apparatus 1 described in the first embodiment.

First, step S401 is executed by the electronic device for executing an application program. Next, step S403 is executed by the electronic device for assigning a system display configuration that corresponds to a first resource as a local display configuration of the application program. Following that, step S405 is executed by the electronic device for detecting a predetermined event, wherein the predetermined event may be an event that the display environment for the application program changes. Please be noted that the step S405 may be executed before the step S403 in some other embodiments.

After that, step S407 is executed by the electronic device for updating the local display configuration of the application program in response to the predetermined event being detected. Next, step S409 is executed by the electronic device for loading a second resource according to the updated local display configuration. It is noted that the step S409 is executed by the application program run on the electronic device. Then, step S411 is executed by the electronic device for rendering the second resource on a display unit after the predetermined event is detected. It is also noted that the step S411 is executed by the application program run on the electronic device.

In addition to the aforesaid steps, the fourth embodiment can also execute all the operations and have all functionalities set forth in the first embodiment. How the fourth embodiment executing these operations and having these functionalities will be readily appreciated by those of ordinary skill in the art based on the explanation of the first embodiment, and thus will not be further described herein.

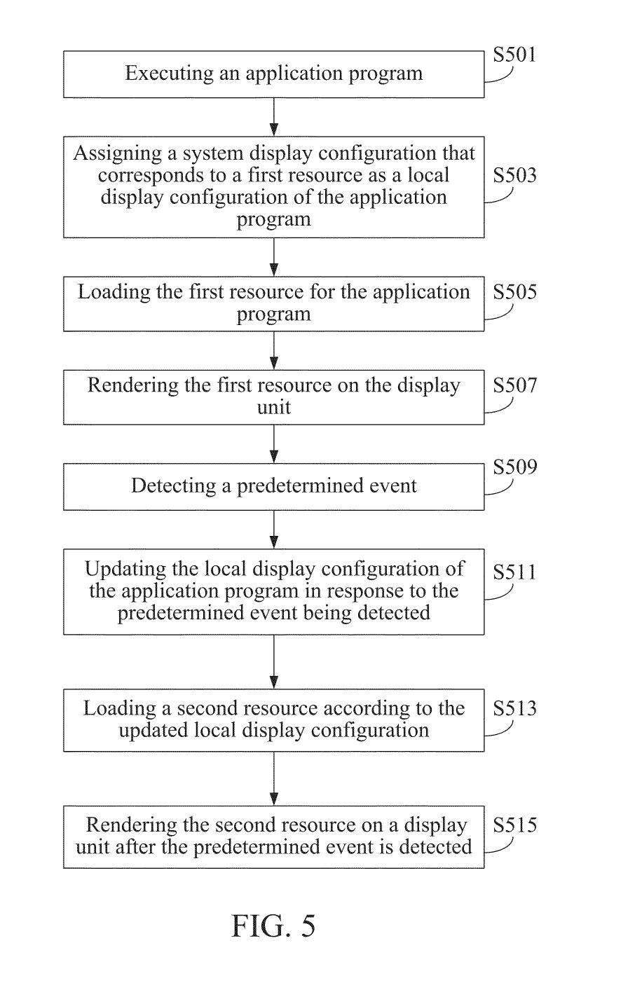

A fifth embodiment of the present invention is a resource adaptive method and a flowchart of which is illustrated in FIG. 5. The resource adaptive method is for use in an electronic device, such as the resource adaptive apparatus 1 described in the first and second embodiments.

First, step S501 is executed by the electronic device for executing an application program. Next, step S503 is executed by the electronic device for assigning a system display configuration that corresponds to a first resource as a local display configuration of the application program. In this embodiment, the first resource is a first display layout for showing the application program on a display unit. Then, step S505 is executed by the electronic device for loading the first resource for the application program. Following that, step S507 is executed by the application program for rendering the first resource on the display unit. It is noted that the step S505 and the step S507 are executed by the application program run on the electronic device.

Next, step S509 is executed by the electronic device for detecting a predetermined event. The predetermined event may be an event that the display environment for the application program changes, such a multi-window environment being launched, a single-window environment being launched, etc. Following that, step S511 is executed by the electronic device for updating the local display configuration of the application program in response to the predetermined event being detected. In some embodiments, the local display configuration comprises a layout height value and a layout width value. For these embodiments, the step S511 updates the local display configuration of the application program updates the layout height value and the layout width value.

Afterwards, step S513 is executed by the electronic device for loading a second resource according to the updated local display configuration. In this embodiment, the second resource is a second display layout for showing the application program on the display unit. Particularly, the first display layout and the second display layout are of different dimensions. Then, step S515 is executed by the electronic device for rendering the second resource on the display unit. It is noted that the step S513 and the step S515 are executed by the application program run on the electronic device.

In addition to the aforesaid steps, the fifth embodiment can also execute all the operations and have all functionalities set forth in the second embodiment. How the fifth embodiment executing these operations and having these functionalities will be readily appreciated by those of ordinary skill in the art based on the explanation of the second embodiment, and thus will not be further described herein.

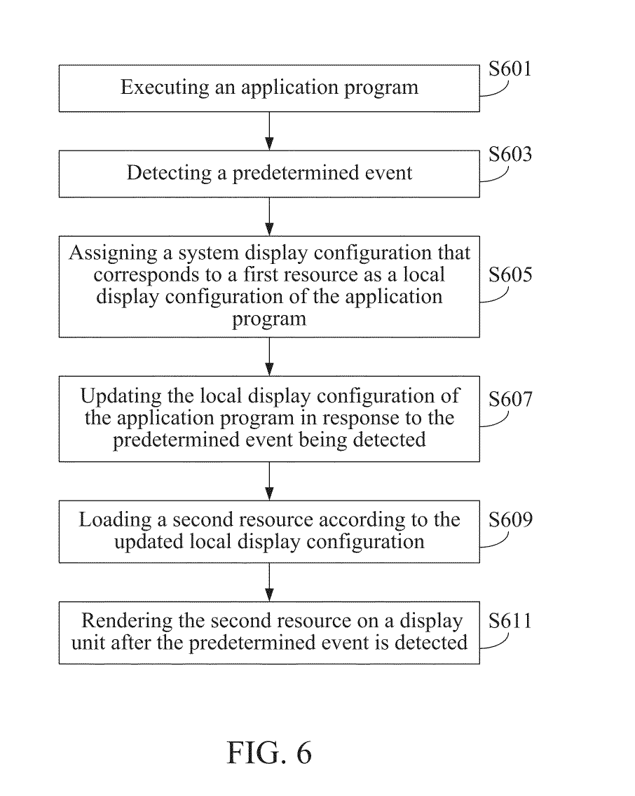

A sixth embodiment of the present invention is a resource adaptive method and a flowchart of which is illustrated in FIG. 6. The resource adaptive method is for use in an electronic device, such as the resource adaptive apparatus 3 described in the third embodiment.

First, step S601 is executed by the electronic device for executing an application program, wherein the application program is designed to be rendered in a first display mode. Next, step S603 is executed by the electronic device for detecting a predetermined event. In this embodiment, the predetermined event is the electronic device being electrically connected to an external electronic apparatus having the display unit placed in a second display mode, which is different from the first display mode of the application program. In some embodiments, one of the first display mode and the second display mode is a portrait mode, while the other one of the first display mode and the second display mode is a landscape mode.

Following that, step S605 is executed by the electronic device for assigning a system display configuration that corresponds to a first resource as a local display configuration of the application program. It is noted that the display unit of the external electronic apparatus has a first display range of the first display mode when being placed in the first display mode, such as the first display range by the first width W1 and the first height H1 as shown in FIG. 3B. The display unit of the external electronic apparatus has a second display range of the first display mode when being placed in the second display mode, such as the second display range by the second width W2 and the second height H2 as shown in FIG. 3C. It is emphasized that the system display configuration referred in the step S605 corresponds to the first display range.

Next, step S607 is executed for updating the local display configuration of the application program in response to the predetermined event being detected so that the updated local display configuration of the application program corresponds to the second display range. In some embodiments, the system display configuration referred in the step S605 is a logical density of the display unit and, hence, the step S607 updates the local display configuration of the application program by updating the logical density. In some embodiments, step S607 may update the local display configuration according to an aspect ratio of the display unit.

Next, step S609 is executed by the electronic device for loading a second resource according to the updated local display configuration. Then, step S611 is executed by the electronic device for rendering the second resource on the display unit of the external electronic apparatus. It is noted that the step S609 and the step S611 are executed by the application program run on the electronic device.

In addition to the aforesaid steps, the sixth embodiment can also execute all the operations and have all functionalities set forth in the third embodiment. How the sixth embodiment executing these operations and having these functionalities will be readily appreciated by those of ordinary skill in the art based on the explanation of the third embodiment, and thus will not be further described herein.

The resource adaptive methods described in the fourth to sixth embodiments may be implemented by a computer program having a plurality of codes. The computer program is a computer program product that can be stored in a non-transitory computer readable storage medium. When the codes are loaded into an electronic device (e.g. the resource adaptive apparatuses 1, 3 in the first to third embodiments), the computer program executes the resource adaptive methods as described in the fourth to sixth embodiments. The non-transitory computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

According to the present invention, an electronic apparatus (or the like) initially assigns a system display configuration as a local display configuration of an application program executed on the electronic apparatus. When a predetermined event is detected (e.g. when the display environment for the application program changes), the electronic apparatus updates the local display configuration of the application program in response to the predetermined event being detected. In this way, after the predetermined event is detected, the application program loads resource(s) according to the updated local display configuration. Since the resource(s) are loaded based on the updated local display configuration, rendering these resource(s) on the display unit provides pleasant visual experience.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A resource adaptive apparatus, comprising:
a first display unit; and
a processing unit, being electrically connected to the first display unit and configured to execute an application program, assign a system display configuration that corresponds to a first resource as a local display configuration of the application program, detect a predetermined event, update the local display configuration of the application program in response to the predetermined event being detected;
wherein the application program loads a second resource according to the updated local display configuration and renders the second resource on at least one of the first display unit and a second display unit after the predetermined event is detected.

2. The resource adaptive apparatus of claim 1, wherein the first resource is a first display layout, the second resource is a second display layout, and the predetermined event is one of a multi-window environment being launched and a single-window environment being launched.

3. The resource adaptive apparatus of claim 1, wherein the first display layout and the second display layout are of different dimensions.

4. The resource adaptive apparatus of claim 1, wherein the local display configuration comprises a layout height value and a layout width value, the processing unit updates the local display configuration of the application program by updating the layout height value and the layout width value.

5. The resource adaptive apparatus of claim 1, wherein the application program loads the first resource according to the local display configuration and renders the first resource on the first display unit before the predetermined event is detected.

6. The resource adaptive apparatus of claim 1, further comprising:
an interface;
wherein the application program is designed to be rendered in a first display mode, the predetermined event is the interface being electrically connected to an external electronic apparatus having the second display unit placed in a second display mode, one of the first display mode and the second display mode is a portrait mode, and the other one of the first display mode and the second display mode is a landscape mode.

7. The resource adaptive apparatus of claim 6, wherein the second display unit has a first display range of the first display mode when being placed in the first display mode, the second display unit has a second display range of the first display mode when being placed in the second display mode, the system display configuration corresponds to the first display range, and the updated local display configuration of the application program corresponds to the second display range.

8. The resource adaptive apparatus of claim 7, wherein the system display configuration is a logical density and the processing unit updates the local display configuration of the application program by updating the logical density.

9. The resource adaptive apparatus of claim 8, wherein the processing unit updates the logical density according to an aspect ratio of the second display unit.

10. A resource adaptive method for use in an electronic device, comprising the following steps of:
executing an application program;
assigning a system display configuration that corresponds to a first resource as a local display configuration of the application program;
detecting a predetermined event; and
updating the local display configuration of the application program in response to the predetermined event being detected so that the application program loads a second resource according to the updated local display configuration and renders the second resource on a display unit after the predetermined event is detected.

11. The resource adaptive method of claim 10, wherein the first resource is a first display layout, the second resource is a second display layout, and the predetermined event is one of a multi-window environment being launched and a single-window environment being launched.

12. The resource adaptive method of claim 10, wherein the first display layout and the second display layout are of different dimensions.

13. The resource adaptive method of claim 10, wherein the local display configuration comprises a layout height value and a layout width value, the step of updating the local display configuration of the application program updates the layout height value and the layout width value.

14. The resource adaptive method of claim 10, further comprising the steps of:
loading the first resource for the application program according to the local display configuration before the predetermined event is detected; and
rendering the first resource on the display unit for the application program before the predetermined event is detected.

15. The resource adaptive method of claim 10, wherein the application program is designed to be rendered in a first display mode, the predetermined event is the electronic device being electrically connected to an external electronic apparatus having the display unit placed in a second display mode, one of the first display mode and the second display mode is a portrait mode, and the other one of the first display mode and the second display mode is a landscape mode.

16. The resource adaptive method of claim 15, wherein the display unit has a first display range of the first display mode when being placed in the first display mode, the display unit has a second display range of the first display mode when being placed in the second display mode, the system display configuration corresponds to the first display range, and the updated local display configuration of the application program corresponds to the second display range.

17. The resource adaptive method of claim 16, wherein the system display configuration is a logical density of the display unit and the step of updating the local display configuration of the application program updates the logical density.

18. The resource adaptive method of claim 17, wherein the step of updating the local display configuration updates the logical density according to an aspect ratio of the display unit.

19. A non-transitory computer readable storage medium, having a computer program stored therein, the computer program executing a resource adaptive method after being loaded into an electronic device, and the resource adaptive method comprising the following steps of:
executing an application program;
assigning a system display configuration that corresponds to a first resource as a local display configuration of the application program;
detecting a predetermined event; and
updating the local display configuration of the application program in response to the predetermined event being detected so that the application program loads a second resource according to the updated local display configuration and renders the second resource on a display unit after the predetermined event is detected.
